(19) United States
(12) Patent Application Publication
(10) Pub. No.: US 2025/0237837 A1
(43) Pub. Date: Jul. 24, 2025

(54) MULTI-PORT FRONT-LOAD MODULE

(71) Applicant: viaPhoton, Inc., Aurora, IL (US)

(72) Inventors: Mark James SMRHA, Chicago, IL (US); Wade James WOMACK, Allen, TX (US); Walter Mark HENDRIX, Dallas, TX (US); Jeffrey Earl JONES, SR., Stewartstown, PA (US); Nathan Eric BENTON, Dallas, TX (US)

(21) Appl. No.: 19/035,398

(22) Filed: Jan. 23, 2025

Related U.S. Application Data
(60) Provisional application No. 63/624,266, filed on Jan. 23, 2024.
(60) Provisional application No. 63/551,833, filed on Feb. 9, 2024.

(51) Int. Cl. G02B 6/44; G02B 6/38

(52) U.S. Cl. CPC G02B 6/44524; G02B 6/3885; G02B 6/3893; G02B 6/44526

(57) ABSTRACT

An apparatus that includes a module with a set of adapters positioned at its front, facilitating connections for external interfaces. A cable extends out through the front of the module. The cable contains a bundle of fibers internally connected to the set of adapters.

### CROSS-REFERENCE TO RELATED APPLICATIONS

This application claims the benefit of U.S. Provisional Application Ser. No. 63/624,266, filed Jan. 23, 2024, which is hereby incorporated by reference for all purposes. This application claims the benefit of U.S. Provisional Application Ser. No. 64/277,089, filed Feb. 9, 2024, which is hereby incorporated by reference for all purposes.

### BACKGROUND

Equipment racks in data centers and telecommunication rooms are used for housing various rack-mounted panels and equipment. Network equipment is installed inside the available rack spaces. Data center infrastructure should be managed to optimize the use of available rack space while accommodating an increasing density of fiber connections. As organizations strive for more scalable and flexible network infrastructures, cable management and equipment installation practices must be considered.

In conventional rack-mount panels, cables can be connected either from the back or the front of cabinet-mounted network equipment. The myriads of necessary connections often leads to cable clutter in congested spaces. In environments where rear access is either limited or entirely unfeasible, the limitation in access and the complexity of managing connections in tight spaces can lead to increased installation times, higher risks of cable damage, and difficulties in maintenance and troubleshooting. Restricted access to the rear of equipment complicates maintenance and upgrades for routing cables or fibers, and increasing the likelihood of significant downtime and operational disruptions when installing or modifying network infrastructure.

### SUMMARY

The illustrative embodiments provide an apparatus that includes a module with a set of adapters positioned at its front, facilitating connections for external interfaces. A cable extends out through the front of the module and contains a bundle of fibers internally connected to the set of adapters. This configuration enables the fibers within the cable to interface directly with the adapters, providing a compact and front-accessible design for managing fiber connections.

Other aspects of one or more embodiments will be apparent from the following description and the appended claims.

### BRIEF DESCRIPTION OF DRAWINGS

FIG. 1 shows a rack in accordance with one or more embodiments.

FIGS. 2A and 2B show rack mount panels, fully loaded with multi-port front load modules, in accordance with one or more embodiments.

FIG. 3 shows a front-view of a multi-port front load module, in accordance with one or more embodiments.

FIG. 4 shows a front perspective view of module (212) according to illustrative embodiments.

FIG. 5 shows a front perspective view of module (212) according to illustrative embodiments.

FIG. 6 shows a panel having multiple modules attached thereto according to illustrative embodiments.

FIG. 7 shows a block diagram of a multi-port front load module according to illustrative embodiments.

FIG. 8 shows a multi-port front loading module according to illustrative embodiments.

FIGS. 9A and 9B show exploded views of a module according to illustrative embodiments.

FIGS. 10A, 10B, and 10C show a cable management clip according to illustrative embodiments.

FIGS. 11A and 11B show a cable management clip according to illustrative embodiments.

FIG. 12 shows an alternative configuration of the multi-port front load module in accordance with one or more embodiments.

FIG. 13 shows an alternative configuration of the multi-port front load module in accordance with one or more embodiments.

FIG. 14 shows an alternative configuration of the multi-port front load module in accordance with one or more embodiments.

Like elements in the various figures are denoted by like reference numerals for consistency.

### DETAILED DESCRIPTION

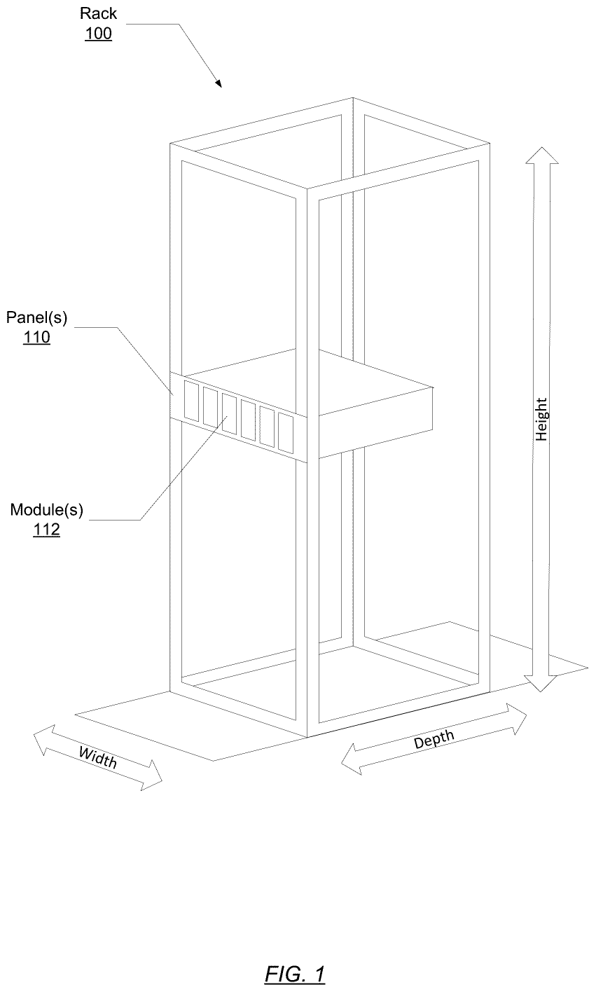

Turning to FIG. 1, a rack is shown in accordance with one or more embodiments. The rack (100) is a piece of telecommunications equipment that provides for the housing and organization of diverse telecommunication devices.

The outer dimensions of rack (100), including rack width (104) and rack depth (106), aligns with the widths of most network and server equipment. For example, rack width (104) may measure 19 inches (48.26 cm) or 23 inches (58.42 cm) in width, standard measurements that are adhered to in the telecommunications industry. Other dimensions may be used, e.g., 21 inches, 23 inches, etc. The rack height (102), and rack width (104), and rack depth (106) dimensions ensure that the rack can accommodate equipment with different form factors, such as 1 U, 2 U, or larger units, where “U” represents a standard rack unit of measure equal to 1.75 inches in height.

The rack (100) may include a series of uniformly spaced vertical mounting slots, located on both the front and rear, to facilitate the arrangement and mounting of various telecommunication devices and components. The slots serve as attachment points for mounting the panel(s) (110). The rack (100) may further be equipped with additional features such as ventilation openings and cable management.

Panel(s) (110) are components that mount within the rack (100) to organize, secure, and provide access to connective hardware. Panel(s) (110) are formed with standardized form factors for compatibility with the mounting slots of the rack (100). For example, panel(s) (110) may include standardized mounting points to align with rack units, a layout that supports the intended cable or connector density, and provisions for labeling and user accessibility.

The panel(s) (110) may be equipped with one or more module(s) (112) to secure the fibers using ports, connector adapters, adapters, etc. Module(s) (112) are prefabricated units or sub-assemblies designed for quick installation into the rack (100). The module(s) (112) may house electronic components, such as switches, routers, or patches. The module(s) (112) may include features for splicing, cable management, and security.

The dimensions of the module(s) (112) conform to the standard dimensions of a rack (100). For example, the height of module(s) (112) may be 1 RU, or a multiple the standard 1 RU dimension, e.g., 2 RU, 3 RU, etc. The width for each of the module(s) (112) may enable a group of the module(s) (112) to fit within one of the panel(s) (110). For example, the width of each module(s) (112) may be selected such that a number of modules (e.g., 4, 6, 8, 10, 12, etc.) can be accommodated within the rack width (104).

The front end of the module(s) (112) is exposed through the front of one of the panel(s) (110) and through the front of the rack (100). The front end of the module(s) (112) may include interfaces for power and data connectivity. For example, the module(s) (112) may include a group of the connector adapters to accommodate one or more optical connectors, such as LC connectors, SC connectors, ST connectors, etc.

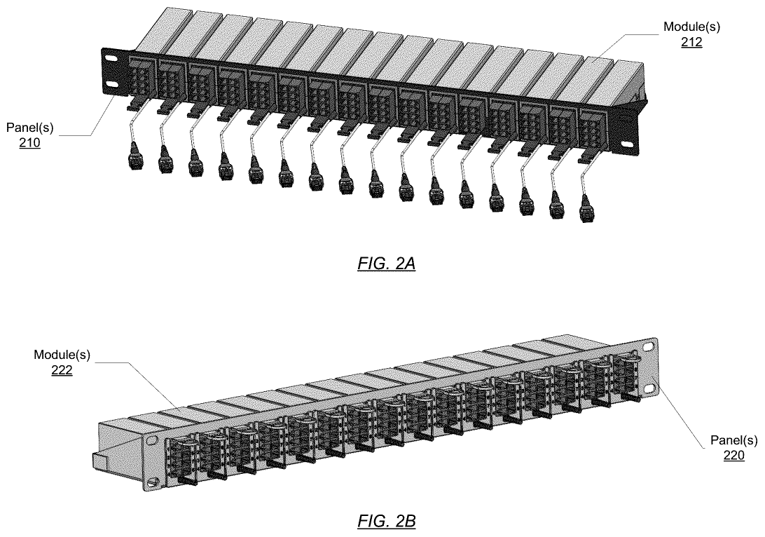

FIGS. 2A and 2B show rack mount panels, fully loaded with multi-port front load modules, in accordance with one or more embodiments.

The panel(s) (210) and/or panel(s) (220) may be sized to fit into one RU (rack unit) of space of a rack, such as rack (100) of FIG. 1. One or more module(s) (212) and/or module(s) (222) may be inserted and secured into the panel(s). The module(s) (212) and module(s) (222) may implement the module(s) (112) of FIG. 1.

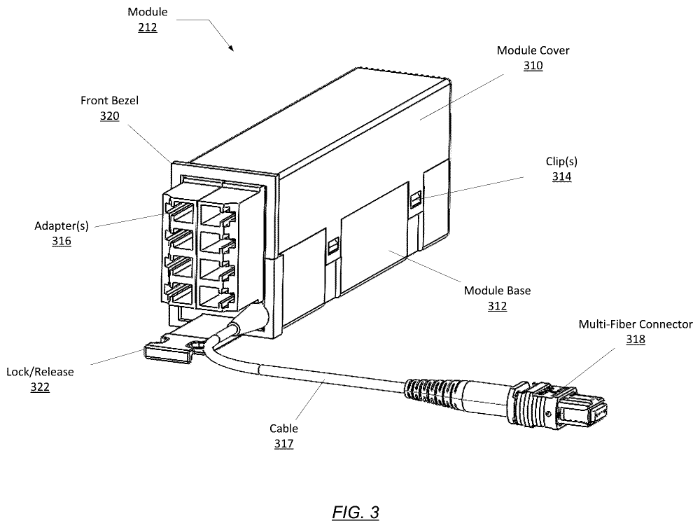

FIG. 3 shows a front-view of a multi-port front load module, in accordance with one or more embodiments. The module (212) can be a multi-port front load module that is integrated into larger systems or racks commonly found in data centers to provide network connectivity.

The module (212) includes a housing that is designed to fit within standard equipment racks used in data centers. The housing, comprised of module cover (310) and module base (312), serves as the main body of the module, protecting the internal components from physical damage and/or electromagnetic interference. The module cover (310) and module base (312) may be releasably secured together by clip(s) (314). The housing may contain the necessary circuitry to facilitate network communication through the multi-port interface (103).

The multi-port front load module (212) includes one or more interface adapter(s) (316). Each of the adapter(s) (316) provides a connection point for individual cables, and may house connection jacks or adapters for the various network cables. In some embodiments, the adapter(s) (316) are Lucent Connector (LC) adapter(s) for joining fiber optic cables.

The front bezel (320) is located at the forward-facing end of the module. It is designed to interface with multiple adapter(s) (316), which are configured to receive connectors from external devices or systems. The adapter(s) (316) are positioned to protrude slightly from the front bezel (320), facilitating accessibility. The adapter(s) (316) may be arranged in a grid formation and serve as the interface points for connecting individual fibers.

One or more multi-fiber cable(s) (317) may be provided to connect with other modules. The multi-fiber cable(s) (317) extends through the front of the multi-port front load module (212), interfacing with internal fiber routing components housed within the module and connecting with the adapter(s) (316). The cable(s) (317) may include a multi-fiber connector (318), which can be a Multi-fiber Push On (MPO) type connector that contains multiple fiber connections, e.g., 8, 12, or 16, within a single connector. The MPO connector allows for simultaneous connection of multiple fibers, streamlining the connection process and enabling higher bandwidth in high-speed networks.

The multi-port front load module (212) may include a lock/release tab (322). Lock/release tab (322) interfaces with a rack, ensuring that the multi-port front load module (212) is securely fastened in place during use and can be easily released when necessary, such as for maintenance or module replacement. The lock/release tab (322) may operate on a push-to-lock and pull-to-unlock mechanism. In some embodiments, the lock/release tab (322) may be provided colored to serve as a visual indicator of the engaged or disengaged state of the lock.

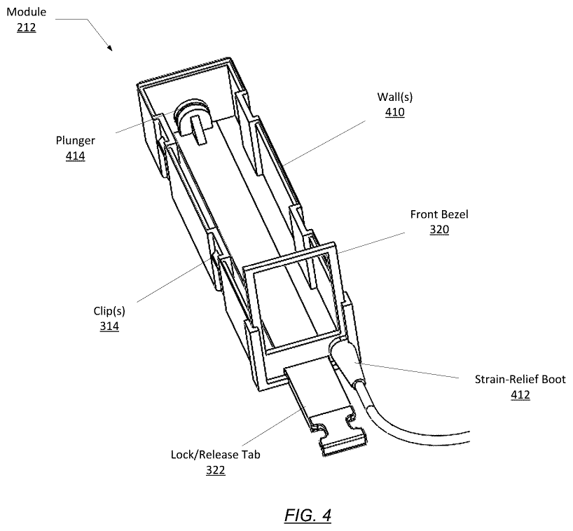

Referring now to FIG. 4, a front perspective view of module (212) is shown according to illustrative embodiments, the module (212) is depicted with the module cover removed, revealing the internal arrangement and interrelation of components. The clip(s) (314) facilitate attachment and removal of the module cover.

The walls (410) form the structural boundaries of the module, enclosing the internal cavity and providing alignment for the front bezel (320) and other internal components. The front bezel (320) interfaces with the walls and supports the mounting of adapters or other connection interfaces at the forward end. A strain-relief boot (412) is positioned at the front of the module, securing an incoming cable, and reducing mechanical stress on the connection.

The lock/release tab (322) serves as an actuation mechanism of the plunger (414), which can be unitary therewith. The plunger (414) extends longitudinally along the internal cavity and is aligned with the walls to enable smooth actuation. When operated, the tab advances the plunger into a mating grommet (not shown in this FIG.), locking, or releasing the module in place within a panel.

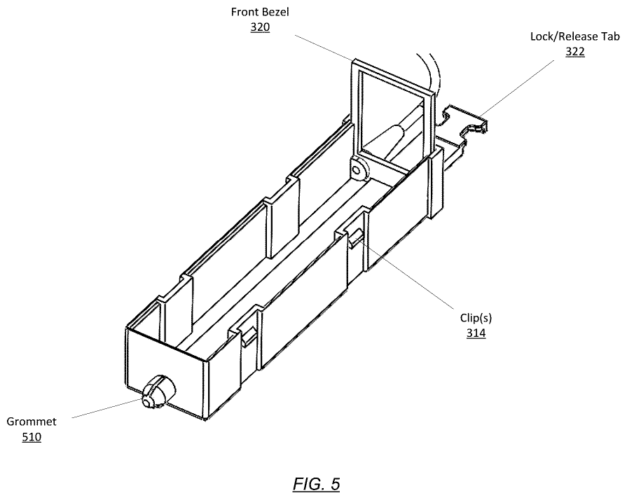

Referring now to FIG. 5, a front perspective view of module (212) is shown according to illustrative embodiments, the module (212) is depicted with the module cover removed, revealing the internal arrangement and interrelation of components.

The walls (410) extend longitudinally along the sides of the housing, supporting the front bezel (320) and the grommet (510). A grommet (510) is positioned at the rear section of the housing to interact with the plunger (414) described previously. The grommet (510) is aligned with the rear opening of the module, allowing it to function as an anchoring point for the plunger. Actuation of lock/release tab (322) affects the plunger to engage or disengage with the grommet, providing a locking mechanism for securing the module in place during installation. The lock/release tab (322) operates in conjunction with the plunger (414) and grommet (510) to enable tool-free locking and release of the module.

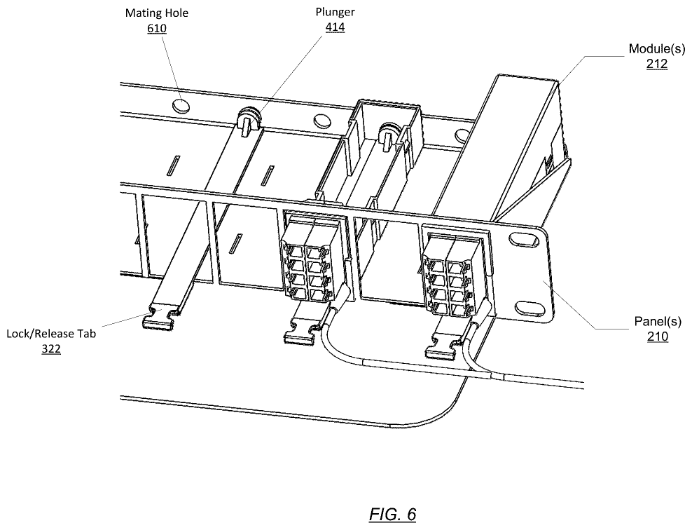

Referring now to FIG. 6, a panel is shown having multiple modules attached thereto according to illustrative embodiments. The panel (210) contains multiple bays designed to receive and secure the modules (212) in a front-loaded configuration. Each module(s) (212) is positioned within n bay of the panel (210), with all connections provided through the front of the module.

Grommet (510) (shown in FIG. 5) each module is aligned with its corresponding mating hole (610). The lock/release tabs (322) of each module interact with corresponding mating holes (610) located on the panel (210). When the lock/release tabs (322) is actuated, the plunger (414) expands the grommet within the mating holes (610) to secure the modules in place.

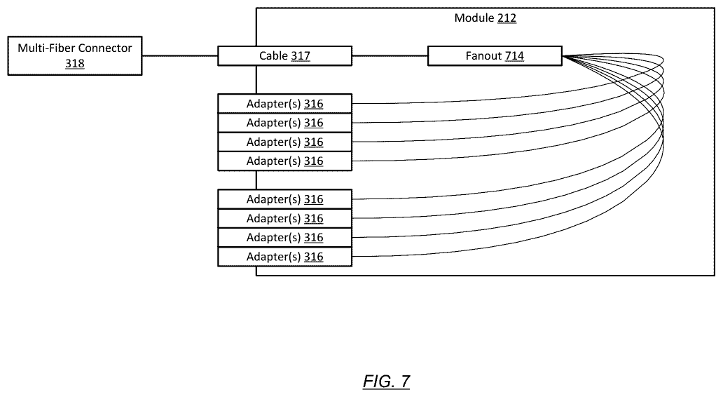

Referring now to FIG. 7, a block diagram of a multi-port front load module is shown according to illustrative embodiments. The multiport front load module (212) illustrates the internal fiber connections between the multi-fiber connector (318) and adapters (316). The multi-fiber connector (318) is connected to a cable (712) that routes fibers into the module.

The cable (712) terminates at a fanout (714) located within the module. The fanout (714) distributes the individual fibers from the cable into separate pathways, enabling connection to multiple adapters (316). The multi-fiber connector (318), cable (712), and fanout (714) work in coordination to support the transition from a single multi-fiber input to multiple individual fiber outputs.

The adapters (316) are organized in an array and positioned to facilitate external fiber connections. Each adapter (316) receives one fiber from the fanout (714), providing discrete interface points for external devices or systems. The fanout ensures that the fibers are routed in a controlled manner to maintain signal integrity and prevent strain.

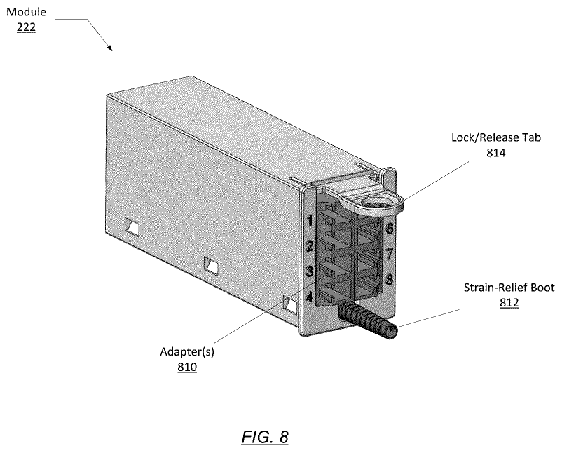

Referring now to FIG. 8, a multi-port front loading module is shown according to illustrative embodiments. The adapter(s) (810) remain accessible from the front face of the module, providing connection points for individual fibers.

Module (222) includes a front-facing lock/release tab (814), which operates as a clip mechanism. This lock/release tab (814) secures the module at the front of a panel, eliminating the need for a sliding lock/release mechanism like the previously described lock/release tab (322). The tab (814) engages directly with the panel to maintain the module's position during installation and operation.

In absence of the sliding lock/release mechanism, strain-relief boot (812) is repositioned towards the center of the module base. This configuration allows the strain-relief boot (812) to maintain its functionality in securing and protecting the cable from mechanical stress while optimizing the internal arrangement of the module components.

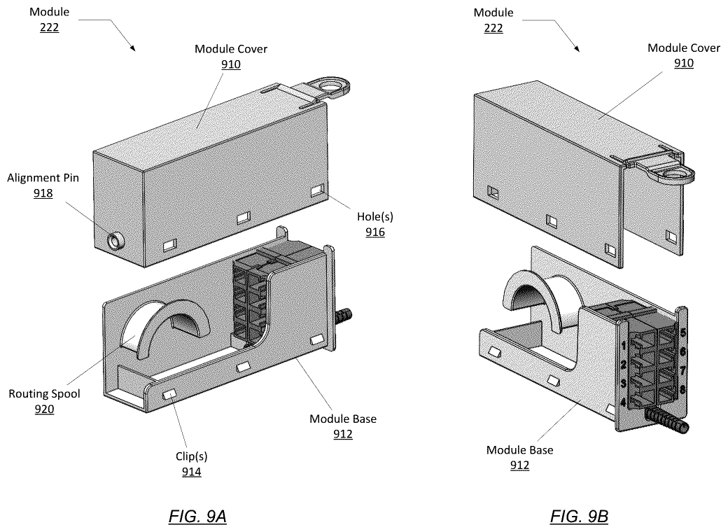

Referring now to FIGS. 9A and 9B, exploded views of a module are shown according to illustrative embodiments. As depicted, module (222) includes the module cover (910), module base (912), and associated components.

The module cover (910) is designed to enclose the module base (912) and is equipped with hole(s) (916) for securing the cover to the base. Clip(s) (914) are integrated into the module base (912) and provide attachment points for securing the module cover (910). An alignment pin (918) is positioned on the module base (912) to ensure proper alignment of the base with a mating hole of a panel, such as mating hole (610) of FIG. 6.

Routing spool (920) is positioned within the module base (912) to manage and organize internal fiber routing. The routing spool (920) facilitates controlled fiber bends and prevents strain on the fibers that transition to the adapter(s) within the base.

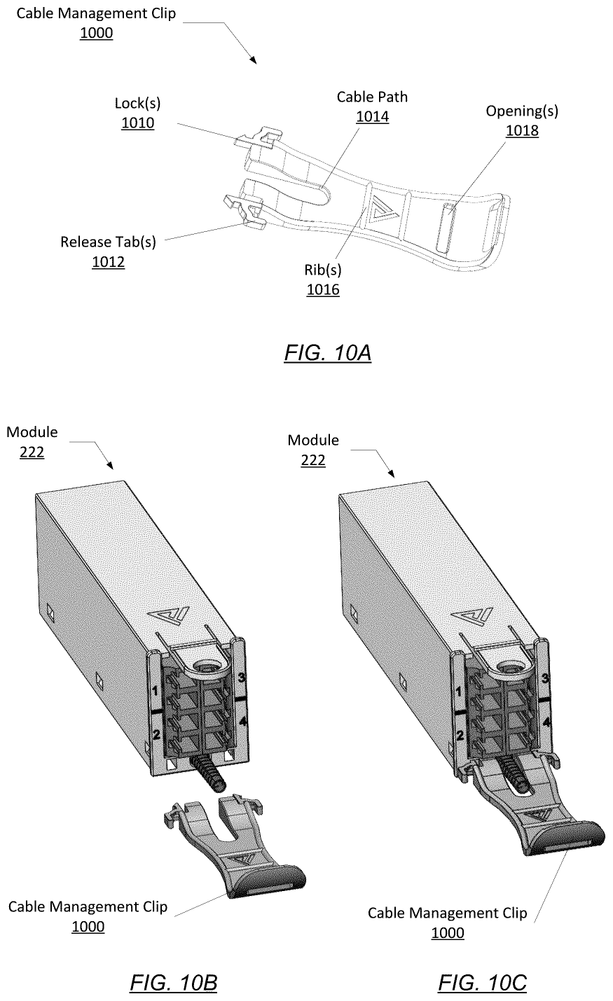

Referring now to FIGS. 10A, 10B, and 10C, a cable management clip is shown according to illustrative embodiments. The cable management clip (1000) configured to integrate with the module (222).

The cable management clip (1000) includes a cable path (1014) to route and organize cables extending from the module. Lock(s) (1010) are positioned at the base of the clip and engage with corresponding features on the module, securing the clip in place. The release tab(s) (1012) facilitate disengagement of the clip from the module, allowing for tool-free attachment and removal.

Rib(s) (1016) are located along the structure of the clip, providing structural reinforcement, and maintaining the integrity of the cable path (1014). Fasteners, such as a hook and loop strap, can be used to secure cables to the cable management clip (1000) via the opening(s) (1018).

FIGS. 10B and 10C illustrate the cable management clip (1000) positioned below the module (222) prior to attachment and in its final assembled state. When installed, the cable path (1014) aligns with the strain relief boot of the module, organizing the cables as they exit the module.

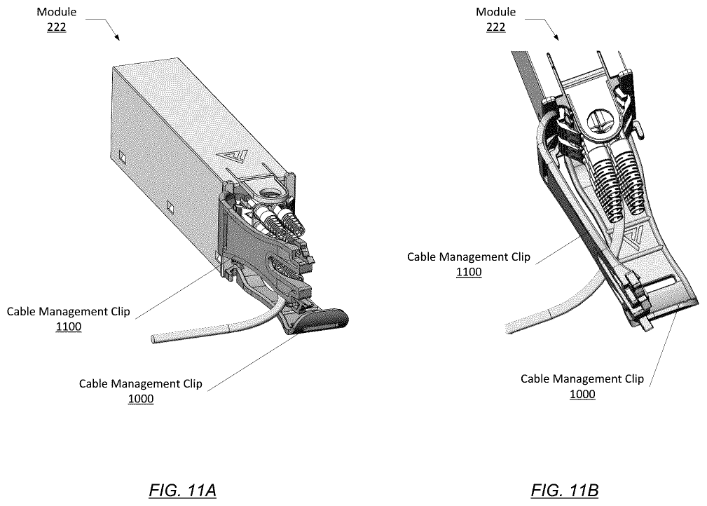

Referring now to FIGS. 11A and 11B, a cable management clip is shown according to illustrative embodiments. The cable management clip (1100) is configured to integrate with the module (222).

The cable management clip (1100) is configured for installation along a side edge of the module (222). The cable management clip (1100) is positioned laterally, secured along the side edge of the module to provide an additional pathway for cable routing. It includes integrated features for guiding and retaining individual cables, ensuring proper alignment with the module's output.

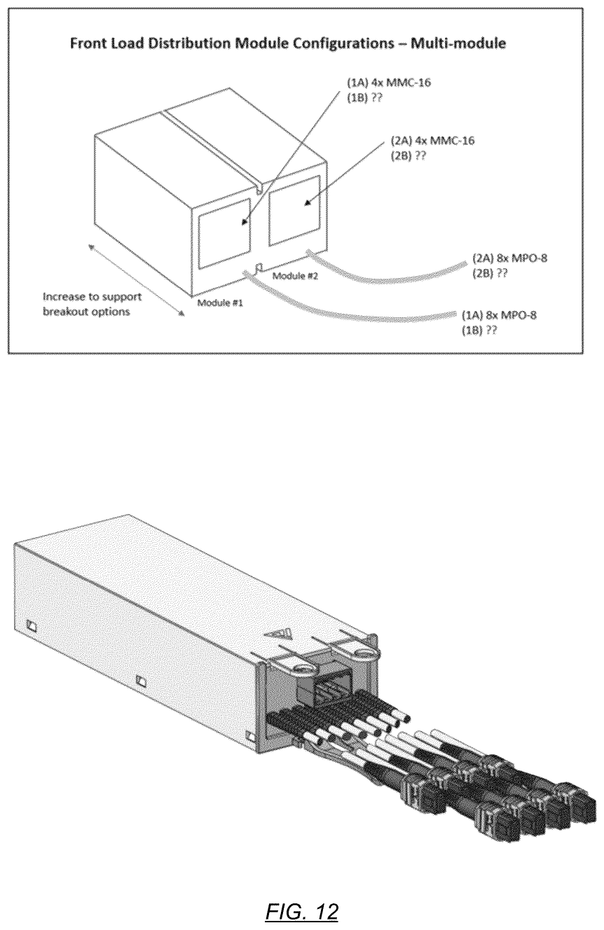

Referring now to FIG. 12, an alternative embodiment of the multi-port front load module is shown in accordance with one or more embodiments. The depicted configuration may also include options for breakout cables, such as the MPO-8 connector that can manage eight fibers, facilitating high-density connections.

As illustrated, the multi-port front load module can be designed in multiple widths for the module. These multiple widths may allow for a varying number of adapters to be housed within the module, accommodating different customer requirements.

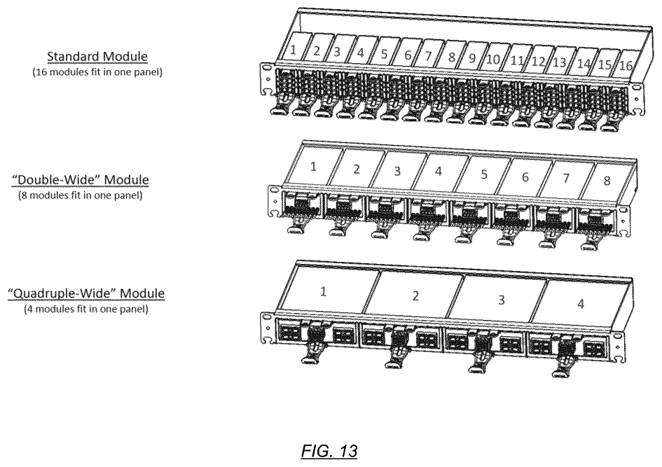

For example, as illustrated in FIG. 13, a standard “single-wide” configuration may hold sixteen (16) modules in a 19″ 1RU panel, a “double-wide” configuration may fit eight (8) modules in a 19″ 1RU panel, while a “quadruple-wide” configuration may fit four (4) modules in a 19″ 1RU panel.

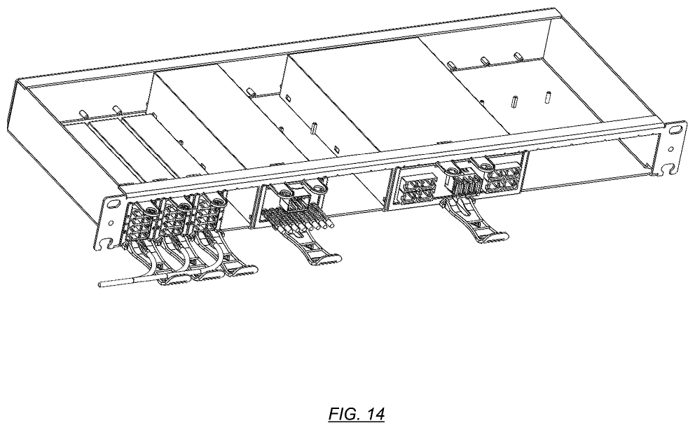

As shown in FIG. 14, modules having different configurations may be mounted within a single rack. In other words, a set of one or more of single wide modules, double wide modules, and quadruple wide modules may be mounted within a single rack.

While FIGS. 1-14 show a configuration of components, other configurations may be used without departing from the scope of one or more embodiments. For example, various components may be combined to create a single component. As another example, the functionality performed by a single component may be performed by two or more components.

As used herein, the term “connected to” contemplates multiple meanings. A connection may be direct or indirect (e.g., through another component or network). A connection may be wired or wireless. A connection may be a temporary, permanent, or semi-permanent communication channel between two entities.

The various descriptions of the figures may be combined and may include or be included within the features described in the other figures of the application. The various elements, systems, components, and steps shown in the figures may be omitted, repeated, combined, or altered as shown in the figures. Accordingly, the scope of the present disclosure should not be considered limited to the specific arrangements shown in the figures.

In the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, ordinal numbers distinguish between the elements. By way of an example, a first element is distinct from a second element, and the first element may encompass more than one element and succeed (or precede) the second element in an ordering of elements.

Further, unless expressly stated otherwise, the conjunction “or” is an inclusive “or” and, as such, automatically includes the conjunction “and” unless expressly stated otherwise. Further, items joined by the conjunction “or” may include any combination of the items with any number of each item, unless expressly stated otherwise.

In the above description, numerous specific details are set forth in order to provide a more thorough understanding of the disclosure. However, it will be apparent to one of ordinary skill in the art that the technology may be practiced without these specific details. In other instances, well-known features have not been described in detail to avoid unnecessarily complicating the description. Further, other embodiments not explicitly described above can be devised which do not depart from the scope of the claims as disclosed herein. Accordingly, the scope should be limited only by the attached claims.

What is claimed is:

1. An apparatus comprising:
a set of adapters at a front of a module; and
a cable extending out through the front of the module, wherein the cable comprises a bundle of fibers connected to the set of adapters.

2. The apparatus of claim 1 further comprising:
a module cover and a module base that comprise a housing of the module; and
a front bezel that retain these set of adapters, wherein the set of adapters extend through the front bezel of the module.

3. The apparatus of claim 1, wherein the set of adapters comprises adapters to accommodate optical connector is selected from the group comprising one or more LC connectors, SC connectors, ST connectors, and combinations thereof.

4. The apparatus of claim 1, wherein the bundle of fibers consists of 8, 12, or 16 optical fibers.

5. The apparatus of claim 1, wherein the cable further comprises a Multi-fiber Push On (MPO) type connector that contains multiple fiber connections.

6. The apparatus of claim 1, further comprising:
a lock/release tab that is configured to secure the module within a panel, wherein the lock/release tab is selected from a sliding lock/release mechanism that secures the module to a rear of the panel, and a clip that secures the module to a front of the panel.

7. The apparatus of claim 6, where in the sliding lock/release mechanism further comprises:
a plunger, operably connected to a lock/release tab at the front the front of the module; and
a grommet secured to a rear of the module, wherein actuation of the lock/release tab inserts the plunger into the grommet.

8. The apparatus of claim 1, further comprising:
a cable management clip, wherein the cable management clip is configured to attach to the front of the module along a bottom edge or a side edge of the module.

9. The apparatus of claim 1, wherein the module further comprises a standard “single-wide” configuration that fits sixteen (16) modules in a 19″ 1RU panel, a “double-wide” configuration that fits eight (8) modules in a 19″ 1RU panel, or a “quadruple-wide” configuration that fits four (4) modules in a 19″ 1RU panel.

10. A system comprising:
a panel; and
a set of modules inserted into the panel, wherein a module of the set of modules comprises:
a set of adapters at a front of the module; and
a cable extending out through the front of the module, wherein the cable comprises a bundle of fibers connected to the set of adapters.

11. A multi-port front load module comprising:
a set of adapters at a front of the multi-port front load module; and
a cable extending out through the front of the multi-port front load module, wherein the cable comprises a bundle of fibers connected to the set of adapters.

12. The multi-port front load module of claim 11 further comprising:
a module cover and a module base that comprise a housing of the module; and
a front bezel that retain these set of adapters, wherein the set of adapters extend through the front bezel of the module.

13. The multi-port front load module of claim 11, wherein the set of adapters comprises adapters to accommodate optical connector is selected from the group comprising one or more LC connectors, SC connectors, ST connectors, and combinations thereof.

14. The multi-port front load module of claim 11, wherein the bundle of fibers consists of 8, 12, or 16 optical fibers.

15. The multi-port front load module of claim 11, wherein the cable further comprises a Multi-fiber Push On (MPO) type connector that contains multiple fiber connections.

16. The multi-port front load module of claim 11, further comprising:
a lock/release tab that is configured to secure the module within a panel, wherein the lock/release tab is selected from a sliding lock/release mechanism that secures the module to a rear of the panel, and a clip that secures the module to a front of the panel.

17. The multi-port front load module of claim 16, where in the sliding lock/release mechanism further comprises:
a plunger, operably connected to a lock/release tab at the front the front of the module; and
a grommet secured to a rear of the module, wherein actuation of the lock/release tab inserts the plunger into the grommet.

18. The multi-port front load module of claim 11, further comprising:
a cable management clip, wherein the cable management clip is configured to attach to the front of the module along a bottom edge or a side edge of the module.

19. The multi-port front load module of claim 11, wherein the module further comprises a standard “single-wide” configuration that fits sixteen (16) modules in a 19″ 1RU panel, a “double-wide” configuration that fits eight (8) modules in a 19″ 1RU panel, or a “quadruple-wide” configuration that fits four (4) modules in a 19″ 1RU panel.
